(19) United States
(12) Patent Application Publication
(10) Pub. No.: US 2024/0034857 A1
(43) Pub. Date: Feb. 1, 2024

(54) FLAME-RETARDED THERMOPLASTIC POLYURETHANE

(71) Applicant: BASF SE, Ludwigshafen am Rhein (DE)

(72) Inventors: Oliver Steffen Henze, Lemfoerde (DE); Oliver Muehren, Lemfoerde (DE); Tanja Lange, Lemfoerde (DE); Rebecca Spreen, Lemfoerde (DE)

(73) Assignee: BASF SE, Ludwigshafen am Rhein (DE)

(21) Appl. No.: 18/258,345

(22) PCT Filed: Dec. 21, 2021
(86) PCT No.: PCT/EP2021/087062

§ 371 Date: Jun. 20, 2023

(30) Foreign Application Priority Data
Dec. 21, 2020 (EP) 20215970.3

(51) Int. Cl. C08K 5/52; C08K 3/36; C08K 5/53; C08K 5/521

(52) U.S. Cl. CPC C08K 5/5205; C08K 3/36; C08K 5/53; C08K 5/521; C08K 2201/005

(57) ABSTRACT

A composition contains a thermoplastic polyurethane, a first flame retardant (F1) selected from piperazine pyrophosphate and polypiperazine pyrophosphate, and a phosphorus-containing flame retardant (F2) selected from derivatives of phosphinic acid, derivatives of phosphoric acid, and derivatives of phosphoric acid. The composition is useful for production of cable sheathings,

The present invention is directed to a composition comprising a thermoplastic polyurethane, a first flame retardant (F1) selected from the group consisting of piperazine pyrophosphate and polypiperazine pyrophosphate and a phosphorus-containing flame retardant (F2) selected from the group consisting of derivatives of phosphinic acid, derivatives of phosphonic acid and derivatives of phosphoric acid, as well as the use of a composition according to the present invention for the production of cable sheathings.

Flame-retarded thermoplastic polyurethanes are widely used for example in cable production as cable sheathings. A common requirement here is for thin cables having thin cable sheathings which not only pass the relevant flame tests (e.g. VW1) but also have adequate mechanical properties.

The thermoplastic polyurethanes (TPUs) may be admixed either with halogen-containing or halogen-free flame retardants. The thermoplastic polyurethanes comprising halogen-free flame retardants generally have the advantage of evolving less toxic and less corrosive smoke gases when burnt. Halogen-free flame-retarded TPUs are described, for example, in EP 0 617 079 A2, WO 2006/121549 A1 or WO 03/066723 A2. US 2013/0059955 A1 also discloses halogen-free TPU compositions comprising phosphate-based flame retardants.

US 2013/0081853 A1 relates to halogen-free flame-retardant compositions comprising a TPU polymer and a polyolefin and also phosphorus-based flame retardants and further additives. According to US 2013/0081853 A1, the compositions have good mechanical properties.

Usually, several flame retardants are combined to adapt the properties of the composition. US 2019/0031829 A1 discloses a thermoplastic polyurethane resin composition containing a thermoplastic polyurethane resin; at least one melamine salt selected from the group consisting of melamine orthophosphate, melamine pyrophosphate, and melamine polyphosphate; at least one piperazine salt. Also, EP 2 751 204 B1 discloses a TPU based resin comprising a metal hydrate, a nitrogen-based phosphorus flame retardant, and a liquid phosphate modifier.

The use of piperazine based flame retardants is in principle known from the state of the art. WO 2012/174712 A1 discloses a halogen-free flame-retardant polymer composition, comprising a propylene polymer, a thermoplastic elastomer (TPE); and an intumescent flame retardant system comprising a piperazine component. EP 3 135 729 B1 is directed to a flame-retardant thermoplastic polyurethane elastomer composition comprising a thermoplastic polyurethane elastomer and a (poly)phosphate compound for example piperazine polyphosphate.

Melamine cyanurate has also long been known as a flame retardant for engineering plastics. For instance, WO 97/00916 A1 describes melamine cyanurate in combination with tungstic acid/tungstic acid salts as a flame retardant for aliphatic polyamides. EP 0 019 768 A1 discloses the flameproofing of polyamides with a mixture of melamine cyanurate and red phosphorus.

According to WO 03/066723 A1, materials comprising only melamine cyanurate as a flame retardant have neither a good limiting oxygen index (LOI) nor good flame retardancy, determined, for example, by performance in a UL 94 test in the case of thin wall thicknesses. WO 2006/121549 A1 also describes materials comprising as flame retardants a combination of melamine polyphosphate, phosphinate and borate. These materials do attain high LOI values at low wall thicknesses but do not attain good results in the UL 94 test.

For example, materials which comprise as flame retardants combinations of melamine cyanurate with phosphoric esters and phosphonic esters have good results in UL 94V tests but very low LOI values, for example <25%. Such combinations of melamine cyanurate with phosphoric esters and phosphonic esters are inadequate as flame retardants particularly in the case of sheaths of thin cables. A high LOI value is stipulated by standards for various flame retardancy applications, for example in DIN EN 45545.

It has been suggested that melamine might be harmful. Since also melamine-based compounds like melamine cyanurates, melamine phosphate und melamine polyphosphate contain small amounts of melamine it might be advantageous to replace these flame retardants.

Furthermore, thermoplastic polyurethane compositions containing flame retardants based on melamine such as melamine cyanurates, melamine phosphates und melamine polyphosphates often result in opaque materials. For many applications, it is advantageous that the materials are transparent or translucent.

Starting from the prior art the present invention accordingly has for its object to provide flame-retarded thermoplastic polyurethanes having good mechanical properties and good flame retardancy properties while simultaneously having good mechanical and chemicals resistance and undergoing little, if any, discoloration under UV irradiation. The present invention especially has the object to provide flame-retarded thermoplastic polyurethanes having good mechanical properties and good flame retardancy properties while simultaneously exhibiting good mechanical and chemicals resistance and high flexibility. A further object of the present invention is the use of bio-degradable flame retardants.

According to the invention the object is achieved by a composition comprising at least the components (i) to (iii):
(i) a thermoplastic polyurethane,
(ii) a first flame retardant (F1) selected from the group consisting of piperazine pyrophosphate and polypiperazine pyrophosphate;
(iii) a phosphorus-containing flame retardant (F2) selected from the group consisting of derivatives of phosphinic acid, derivatives of phosphonic acid, and derivatives of phosphoric acid.

The compositions according to the invention comprise at least one thermoplastic polyurethane and a combination of two phosphorus-containing flame retardants (F1) and (F2).

It has been found that, surprisingly, the compositions of the invention have an optimized profile of properties as a result of the combination of the components of the invention, especially for use as cable sheathing. It has been found that, surprisingly, the compositions according to the invention have good mechanical properties and excellent flame retardancy. Furthermore, the compositions according to the present invention contain bio-degradable flame retardants and preferably are free of melamine or melamine derivatives. The compositions according to the present invention generally have a low toxicity and are non-corrosive.

As specified the compositions according to the invention comprise a thermoplastic polyurethane as component (i), a first phosphorus-containing flame retardant (F1) selected from the group consisting of piperazine pyrophosphate and polypiperazine pyrophosphate as component (ii) and a further phosphorus-containing flame retardant (F2) selected from the group consisting of derivatives of phosphinic acid, derivatives of phosphonic acid and derivatives of phosphoric acid.

According to the invention the composition preferably is free from melamine or melamine derivatives. In the context of the present invention “free from melamine or melamine derivatives”is to be understood as meaning that the composition comprises less than 50 ppm of melamine or melamine derivatives, preferably less than 20 ppm of melamine or melamine derivatives. In a preferred embodiment the composition comprises 0 ppm of melamine or melamine derivatives.

In the context of the present application melamine or melamine derivatives is to be understood as meaning inter alia all customary and commercially available product qualities.

Furthermore, the composition according to the invention preferably comprises only small amounts of polyhydric alcohols such as for example 3-, 4-, 5- and 6-hydric alcohols. The composition according to the invention is more preferably free from polyhydric alcohols, in particular free from 3-, 4-, 5- and 6-hydric alcohols.

In the context of the present invention “free from 3-, 4-, 5- and 6-hydric alcohols” is to be understood as meaning that the composition comprises less than 50 ppm of polyhdric alcohols, preferably less than 20 ppm of polyhdric alcohols. In a preferred embodiment the composition comprises 0 ppm of polyhydric alcohols

According to the invention, the flame retardant (F1) selected from the group consisting of piperazine pyrophosphate and polypiperazine pyrophosphate. In the context of the present application piperazine pyrophosphate and polypiperazine pyrophosphate are to be understood as meaning inter alia all customary and commercially available product qualities.

In the context of the present invention, (poly)piperazine pyrophosphate used herein means a piperazine pyrophosphate represented by the following formula (I) or (II) or a mixture of the piperazine pyrophosphate represented by the formula (I) and poly(piperazine pyrophosphate) represented by the formula (II):

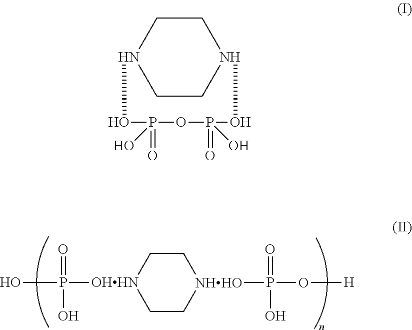

wherein n in formula (II) is an integer of 2 to 100.

Suitable is in particular piperazine pyrophosphate. Therefore, according to one embodiment, the present invention is also directed to a composition as disclosed above, wherein the flame retardant (F1) is piperazine pyrophosphate.

The piperazine pyrophosphate and polypiperazine pyrophosphate used in the context of the present invention may comprise further components such as additives. Preferably, the flame retardant (F1) has a water content of less than 1% by weight, more preferable of less than 0.5% by weight, in particular of less than 0.25% by weight.

According to a further embodiment, the present invention therefore is also directed to a composition as disclosed above, wherein the flame retardant (F1) has a water content of less than 1% by weight.

The piperazine pyrophosphate or polypiperazine pyrophosphate may comprise further additives, for example silica. Preferably, the flame retardant (F1) or the piperazine pyrophosphate used according to the present invention comprises further additives in an amount in the range of from 0.001 to 5% by weight. Preferably, the flame retardant (F1) or the piperazine pyrophosphate used according to the present invention comprises silica in an amount in the range of from 0.001 to 5% by weight, more preferable in an amount in the range of from 0.001 to 2.5% by weight, in particular in an amount in the range of from 0.001 to 0.5% by weight. According to a further embodiment, the present invention therefore is also directed to a composition as disclosed above, wherein the flame retardant (F1) comprises silica in an amount in the range of from 0.001 to 5% by weight.

In the context of the present invention, all customary and commercially available product qualities may be used. The piperazine pyrophosphate and polypiperazine pyrophosphate suitable according to the invention preferably consists of particles typically having an average particle diameter D98 in the range from 5 pm to 100 μm, preferably from 10 μm to 90 μm, particularly preferably 20 μm to 80 μm, very particularly preferably from 30 to 70 μm. A suitable method is to use a powder flame retardant of this type in dry, i.e. free-flowing, form. In the context of the present invention the particle size distribution may be monomodal or else multimodal, for example bimodal.

According to a further embodiment, the present invention therefore also relates to the composition as disclosed above, wherein the flame retardant (F1) has a particle size (d98) in the range from 5 to 100 μm.

The phosphorous content of flame retardant (F1) may vary. Preferably, the flame retardant (F1) has a phosphorous content of more than 15%, in particular of more than 20%. A suitable phosphorous content is for example in the range of from 15 to 30%, in particular 20 to 30%. According to a further embodiment, the present invention therefore is also directed to a composition as disclosed above, wherein the flame retardant (F1) has a phosphorous content of more than 15%.

Compound (F1) is present in the composition of the invention in suitable amounts. For example, the proportion (F1) in the composition is in the range from 1% to 40% by weight based on the total composition, in particular in the range from 2% to 20% by weight, preferably composition in the range from 2% to 10% by weight based on the total composition, in particular in the range from 5% to 10% by weight based on the total composition.

According to a further embodiment, the present invention therefore also relates to the composition as disclosed above, wherein the proportion of the flame retardant (F1) is in the range from 1% to 40% by weight based on the overall composition.

The sum of the components of the composition is 100% by weight in each case.

The composition further comprises a phosphorus-containing flame retardant (F2) selected from the group consisting of derivatives of phosphinic acid, derivatives of phosphonic acid and derivatives of phosphoric acid.

It is preferable when the flame retardant (F2) selected from derivatives of phosphinic acid is selected from salts comprising an organic or inorganic cation or from organic esters. Organic esters are derivatives of phosphinic acid in which at least one oxygen atom bonded directly to the phosphorus has been esterified with an organic radical. In a preferred embodiment the organic ester is an alkyl ester and in another preferred embodiment an aryl ester. It is particularly preferable when all hydroxyl groups of the phosphinic acid have been esterified.

Phosphinic esters have the general formula R1R2(P═O)OR3, wherein all three organic groups R1, R2 and R3 may be identical or different. The radicals R1, R2 and R3 are either aliphatic or aromatic and have 1 to 20 carbon atoms, preferably 1 to 10, more preferably 1 to 3. Preferably at least one of the radicals is aliphatic, preferably all of the radicals are aliphatic, very particularly preferably R1 and R2 are ethyl radicals. It is more preferable when R3 too is an ethyl radical or a methyl radical. In a preferred embodiment R1, R2 and R3 are simultaneously ethyl radicals or methyl radicals.

Also preferred are phosphinates, i.e. the salts of phosphinic acid. The R1 and R2 radicals are either aliphatic or aromatic and have 1 to 20 carbon atoms, preferably 1 to 10, more preferably 1 to 3. Preferably at least one of the radicals is aliphatic, preferably all of the radicals are aliphatic, very particularly preferably R1 and R2 are ethyl radicals. Preferred salts of phosphinic acids are aluminum salts, calcium salts or zinc salts, more preferably aluminum salts or zinc salts. A preferred embodiment is diethylaluminum phosphinate.

Suitable are also alkali metal hypophosphite salts, such as alkali metal salts, alkaline earth metal salts, aluminum salts, titanium salts and zinc salts, in particular aluminum hypophosphite salts and calcium hypophosphite salts.

According to a further embodiment, the present invention therefore also relates to the composition as disclosed above, wherein the phosphorus-containing flame retardant (F2) is selected from the group consisting of derivatives of phosphinic acid.

The combination of flame retardants (F1) and (F2) according to the present invention results in compositions which have excellent flame retardancy. The compositions are preferably self-extinguishing.

The combination of flame retardant (F1) and flame retardant (F2) results in compositions which combine flame retardancy and good values of conductivity and toxicity of smoke gases.

In a further embodiment the present invention therefore relates to a composition as described hereinabove, wherein the phosphorus-containing flame retardant (F2) is a phosphinate.

In a further embodiment the present invention therefore relates to a composition as described hereinabove, wherein the phosphinate is selected from the group consisting of aluminum phosphinates or zinc phosphinates.

The proportion of the flame retardant (F2) in the composition according to the invention is for example in the range from 2% to 25% by weight based on the total composition, in particular 2% to 20% by weight based on the total composition, preferably in the range from 3% to 15% by weight based on the total composition, in particular in the range from 5% to 10% by weight based on the total composition.

According to a further embodiment, the present invention therefore also relates to the composition as disclosed above, wherein the proportion of the flame retardant (F2) in the composition is in the range from 2% to 25% by weight based on the overall composition.

The proportion of the sum of the phosphorus-containing flame retardant (F1) and the phosphorus-containing flame retardant (F2) in the composition is in the range from 3% to 50% by weight based on the total composition, more preferably in the range from 5% to 35% by weight, particularly preferably in the range from 10% to 30% by weight, in each case based on the total composition.

According to a further embodiment, the present invention therefore also relates to the composition as disclosed above, wherein the proportion of the sum of the flame retardant (F1) and the phosphorus-containing flame retardant (F2) in the composition is in the range from 3% to 50% by weight based on the total composition.

It might be advantageous to use the flame retardant (F1) in an amount in the range of from 2% to 10% by weight, preferably in an amount in the range of from 5% to 10% by weight in combination with flame retardant (F2) in an amount in the range of from 5% to 25% by weight, in each case based on the total composition.

According to a further embodiment, the composition comprises flame retardant (F1) in an amount in the range of from 5% to 10% by weight, in combination with flame retardant (F2) in an amount in the range of from 5% to 25% by weight, in each case based on the total composition.

It is preferable in the context of the present invention to employ flame retardants (F2), wherein the particles have an average particle diameter D50 in the range from 0.1 μm to 100 μm, preferably from 0.5 μm to 60 μm, particularly preferably 20 μm to 40 μm. The particles preferably have an average particle diameter D99 of less than 100 μm, more preferably of less than 90 μm. In the context of the present invention the particles preferably have an average particle diameter D50 in the range from 0.1 μm to 100 μm and an average particle diameter D99 of less than 100 μm. In the context of the present invention the particle size distribution may be monomodal or else multimodal, for example bimodal.

According to the invention the composition may also comprise further flame retardants, for example further phosphorus-containing flame retardants such as phosphoric esters. Preferably, the composition comprises further phosphorus-containing flame retardants in an amount in the range of from 1 to 30% by weight.

According to a further embodiment, the present invention is directed to a composition as disclosed above, wherein the proportion of the sum of the flame retardant (F2) and the phosphorus-containing flame retardant (F3) in the composition is in the range from 1% to 30% by weight based on the total composition.

In case the composition comprises a further phosphorus-containing flame retardant (F3) selected from the group consisting of derivatives of phosphoric acid, the phosphorus-containing flame retardant (F2) is selected from the group consisting of derivatives of phosphinic acid and derivatives of phosphonic acid.

According to a further embodiment, the present invention therefore also relates to the composition as disclosed above, wherein the composition comprises a further phosphorus-containing flame retardant (F3) selected from the group consisting of derivatives of phosphoric acid.

Suitable are for example derivatives of phosphoric acid, derivatives of phosphonic acid or derivatives of phosphinic acid or mixtures of two or more of these derivatives. Suitable further flame retardants can for example be liquid at 21° C.

Preferably, the derivatives of phosphoric acid, phosphonic acid or phosphinic acid are salts with an organic or inorganic cation or organic esters. Organic esters are derivatives of the phosphorus-containing acids in which at least one oxygen atom bonded directly to the phosphorus has been esterified with an organic radical. In a preferred embodiment, the organic ester is an alkyl ester, and in another preferred embodiment an aryl ester. More preferably, all hydroxyl groups of the corresponding phosphorus-containing acid have been esterified. Examples of preferred phosphoric esters include phenylene 1,3-bis(diphenyl) phosphate, phenylene 1,3-bis(dixylenyl) phosphate and the corresponding oligomeric products having a mean oligomerization level of n=3 to 6. A preferred resorcinol is resorcinol bis(diphenyl phosphate) (RDP), which is typically present in oligomers.

Further preferred phosphorus-containing flame retardants are bisphenol A bis(diphenyl phosphate) (BDP), which is typically in oligomeric form, and diphenyl cresyl phosphate (DPK).

The amount of the flame retardant (F3) used may vary in wide ranges. The composition may for example comprise the flame retardant (F3) in an amount in the range from1% to 30% by weight based on the overall composition, preferably in an amount in the range from 2% to 25% by weight based on the overall composition, in particular in an amount in the range from 2% to 20% by weight based on the overall composition.

According to a further embodiment, the present invention therefore also relates to the composition as disclosed above, wherein the proportion of the flame retardant (F3) in the composition is in the range from 1% to 30% by weight based on the overall composition.

The composition of the invention further comprises at least one thermoplastic polyurethane. Thermoplastic polyurethanes are known in principle. Production is typically effected by reaction of the components (a) isocyanates and (b) isocyanate-reactive compounds and optionally (c) chain extenders optionally in the presence of at least one (d) catalyst and/or (e) customary auxiliaries and/or additives. The components (a) isocyanate, (b) isocyanate-reactive compounds, (c) chain extenders are also referred to individually or collectively as building block components.

In the context of the present invention the typically employed isocyanates and isocyanate-reactive compounds are suitable in principle.

Preferably employed organic isocyanates (a) include aliphatic, cycloaliphatic, araliphatic and/or aromatic isocyanates, more preferably tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), 3,3′-dimethyl diphenyl diisocyanate, 1,2-diphenylethane diisocyanate and/or phenylene diisocyanate. It is particularly preferable to employ 4,4′-MDI.

In a further embodiment the present invention therefore relates to a composition as described hereinabove, wherein the thermoplastic polyurethane is based on diphenylmethane diisocyanate (MDI).

Employable isocyanate-reactive components (b) include in principle all suitable compounds known to those skilled in the art. According to the invention at least one diol is used as the isocyanate-reactive compound (b).

Any suitable diols may be employed in the context of the present invention, for example polyether diols or polyester diols or mixtures of two or more thereof.

Any suitable polyesterdiols may in principle be employed according to the invention, wherein in the context of the present invention the term polyesterdiol also comprises polycarbonate diols.

One embodiment of the present invention employs a polycarbonate diol or a polytetrahydrofuran polyol. Suitable polytetrahydrofuran polyols have a molecular weight for example in the range from 500 to 5000 g/mol, preferably 500 to 2000 g/mol, particularly preferably 800 to 1200 g/mol.

Suitable polycarbonate diols include for example polycarbonate diols based on alkanediols. Suitable polycarbonate diols are strictly difunctional OH-functional polycarbonate diols, preferably strictly difunctional OH-functional aliphatic polycarbonate diols. Suitable polycarbonate diols are for example based on 1,4-butanediol, 1,5-pentanediol or 1,6-hexanediol, in particular 1,4-butanediol, 1,5-pentanediol, 1,6-hexanediol, 3-methylpentane-(1,5)-diol or mixtures thereof, particularly preferably 1,4-butanediol, 1,5-pentanediol, 1,6-hexanediol or mixtures thereof. Preferably employed in the context of the present invention are polycarbonate diols based on 1,4-butanediol and 1,6-hexanediol, polycarbonate diols based on 1,5-pentanediol and 1,6-hexanediol, polycarbonate diols based on 1,6-hexanediol and mixtures of two or more of these polycarbonate diols.

The compositions according to the invention preferably comprise at least one thermoplastic polyurethane selected from the group consisting of thermoplastic polyurethanes based on at least one diisocyanate and at least one polycarbonate diol and thermoplastic polyurethanes based on at least one diisocyanate and polytetrahydrofuran polyol. Production of the polyurethanes present in the compositions according to the invention accordingly employs as component (b) at least one polycarbonate diol or a polytetrahydrofuran polyol.

In a further embodiment the present invention therefore relates to a composition as described hereinabove, wherein the thermoplastic polyurethane is selected from the group consisting of thermoplastic polyurethanes based on at least one diisocyanate and at least one polycarbonate diol and thermoplastic polyurethanes based on at least one diisocyanate and polytetrahydrofuran polyol. In a further embodiment the present invention therefore relates to a composition as described hereinabove, wherein the thermoplastic polyurethane is selected from the group consisting of thermoplastic polyurethanes based on at least one aromatic diisocyanate and at least one polycarbonate diol and thermoplastic polyurethanes based on at least one aromatic diisocyanate and polytetrahydrofuran polyol.

In a further embodiment the present invention also relates to a composition as described hereinabove, wherein the thermoplastic polyurethane is a thermoplastic polyurethane based on at least one diisocyanate and at least one polycarbonate diol. It is preferable when the employed polycarbonate diols have a number-average molecular weight Mn in the range from 500 to 4000 g/mol determined by GPC, preferably in the range from 650 to 3500 g/mol determined by GPC, particularly preferably in the range from 800 to 2500 g/mol determined by GPC.

In a further embodiment the present invention further relates to a composition as described hereinabove, wherein the thermoplastic polyurethane is a thermoplastic polyurethane based on at least one diisocyanate and at least one polycarbonate diol and the at least one polycarbonate diol is selected from the group consisting of polycarbonate diols based on 1,4-butanediol and 1,6-hexanediol, polycarbonate diols based on 1,5-pentanediol and 1,6-hexanediol, polycarbonate diols based on 1,6-hexanediol and mixtures of two or more of these polycarbonate diols. Also preferred are copolycarbonate diols based on the diols 1,5-pentanediol and 1,6-hexanediol, preferably having a molecular weight Mn of about 2000 g/mol.

In a further embodiment, the present invention therefore relates to a composition as described hereinabove, wherein the polycarbonate diol has a number-average molecular weight Mn in the range from 500 to 5000 g/mol determined by GPC, preferably in the range from 650 to 3500 g/mol determined by GPC, more preferably in the range from 800 to 2500 g/mol determined by GPC.

Preferably employable chain extenders (c) include aliphatic, araliphatic, aromatic and/or cycloaliphatic compounds having a molecular weight of 0.05 kg/mol to 0.499 kg/mol, preferably difunctional compounds, for example diamines and/or alkanediols having 2 to 10 carbon atoms in the alkylene radical, di-, tri-, tetra-, penta-, hexa-, hepta-, octa-, nona- and/or decaalkylene glycols having 3 to 8 carbon atoms, especially 1,2-ethylene glycol, 1,3-propanediol, 1,4-butanediol, 1,6-hexanediol, preferably corresponding oligo- and/or polypropylene glycols, wherein mixtures of the chain extenders may also be employed. The compounds (c) preferably have only primary hydroxyl groups, 1,4-butanediol or a mixture of 1,3-propanediol and 1,4-butanediol being very particularly preferred.

It is also possible according to the invention to employ a polyhydric alcohol, for example propanediol and/or a further diol, that has been obtained at least partially from renewable raw materials. It is possible that the polyhydric alcohol has been partially or entirely obtained from renewable raw materials. According to the invention at least one of the employed polyhydric alcohols may have been at least partially obtained from renewable raw materials.

So-called bio-1,3-propanediol is obtainable for example from maize and/or sugar. A further possibility is the conversion of glycerol wastes from biodiesel production. Also 1,4-butandiol is obtainable from renewable raw materials. In a further preferred embodiment of the invention the polyhdric alcohol is 1,3-propanediol or 1,4-butandiol that has been at least partially obtained from renewable raw materials.

In a further embodiment the present invention accordingly relates to a composition as described hereinabove, wherein the thermoplastic polyurethane is based to an extent of at least 30% on renewable raw materials. One suitable method of determination is the C14 method for example.

In a preferred embodiment catalysts (d) which accelerate especially the reaction between the NCO groups of the diisocyanates (a) and the hydroxyl groups of the isocyanate-reactive compound (b) and the chain extender (c) are tertiary amines, especially triethylamine, dimethylcyclohexylamine, N-methylmorpholine, N,N′-dimethylpiperazine, 2-(dimethylaminoethoxy)ethanol, diazabicyclo[2.2.2]octane; in another preferred embodiment, these are organic metal compounds such as titanate esters, iron compounds, preferably iron(III) acetylacetonate, tin compounds, preferably tin diacetate, tin dioctoate, tin dilaurate or the dialkyltin salts of aliphatic carboxylic acids, preferably dibutyltin diacetate, dibutyltin dilaurate, or bismuth salts in which bismuth is preferably in the oxidation state 2 or 3, especially 3. Salts of carboxylic acids are preferred. Carboxylic acids employed are preferably carboxylic acids having 6 to 14 carbon atoms, particularly preferably having 8 to 12 carbon atoms. Examples of suitable bismuth salts are bismuth(III) neodecanoate, bismuth 2-ethylhexanoate and bismuth octanoate.

The catalysts (d) are preferably used in amounts of 0.0001 to 0.1 part by weight per 100 parts by weight of the isocyanate-reactive compound (b). It is preferable to employ tin catalysts, especially tin dioctoate.

Not only catalysts (d) but also customary auxiliaries (e) may be added to the synthesis components (a) to (c). Examples include surface-active substances, fillers, further flame retardants, nucleation agents, oxidation stabilizers, lubrication and demolding aids, dyes and pigments, optionally stabilizers, for example against hydrolysis, light, heat or discoloration, inorganic and/or organic fillers, reinforcers and plasticizers. Suitable auxiliary and additive substances may be found for example in Kunststoffhandbuch, volume VII, edited by Vieweg and Hochtlen, Carl Hanser Verlag, Munich 1966 (p. 103-113).

Production processes for thermoplastic polyurethanes are disclosed for example in EP 0 922 552 A1, DE 101 03 424 A1 or WO 2006/072461 A1. Production is typically effected on a belt apparatus or in a reactive extruder, but can also be effected on the laboratory scale, for example in a manual casting method. Depending on the physical properties of the components these are all mixed with one another directly or individual components are premixed and/or pre-reacted, for example to give prepolymers, and only then subjected to polyaddition. In a further embodiment a thermoplastic polyurethane is first produced from the building block components, optionally together with catalyst, into which auxiliaries may optionally also be incorporated. In that case, at least one flame retardant is introduced into this material and distributed homogeneously. Homogeneous distribution is preferably effected in an extruder, preferably in a twin-screw extruder. To adjust the hardness of the TPUs, the amounts used of building block components (b) and (c) can be varied within relatively broad molar ratios, typically with rising hardness as the content of chain extender (c) increases.

For producing thermoplastic polyurethanes, for example those having a Shore A hardness of less than 95, preferably from 95 to 80 Shore A, particularly preferably about 85A, the substantially difunctional polyhydroxyl compounds (b) and chain extenders (c) may advantageously be employed in molar ratios of 1:1 to 1:5, preferably 1:1.5 to 1:4.5 so that the resulting mixtures of the building block components (b) and (c) have a hydroxyl equivalent weight of greater than 200 and in particular from 230 to 450 while for producing harder TPUs, for example those having a Shore A hardness of greater than 98, preferably from 55 to 75 Shore D, the molar ratios of (b): (c) are in the range from 1: 5.5 to 1:15, preferably from 1:6 to 1:12 so that the obtained mixtures of (b) and (c) have a hydroxyl equivalent weight of 110 to 200, preferably of 120 to 180.

The thermoplastic polyurethane employed according to the invention preferably has a hardness in the range from 68A to 100A determined according to DIN ISO 7619-1 (Shore hardness test A (3s)), preferably in the range from 70A to 98A determined according to DIN ISO 7619-1, more preferably in the range from 75 A to 95 A determined according to DIN ISO 7619-1, particularly preferably in the range from 75 A to 90 A determined according to DIN ISO 7619-1, especially in the range from 78A to 85A determined according to DIN ISO 7619-1. In an alternative embodiment the employed thermoplastic polyurethane preferably has a hardness in the range from to 80A determined according to DIN ISO 7619-1 (Shore hardness test A (3s)).

In a further embodiment the present invention therefore relates to a composition as described hereinabove, wherein the thermoplastic polyurethane has a Shore hardness in the range from to 100A determined according to DIN 53505.

For producing the thermoplastic polyurethanes employed according to the invention the building block components (a), (b) and (c), preferably in the presence of catalysts (d) and optionally auxiliaries and/or additives (e), are typically reacted in amounts such that the equivalent ratio of NCO groups of the diisocyanates (a) to the sum of the hydroxyl groups of the building block components (b) and (c) is 0.9 to 1.1:1, preferably 0.95 to 1.05:1 and especially about 1.0 to 1.04:1.

The composition according to the invention comprises the at least one thermoplastic polyurethane in an amount in the range from 50% by weight to 95% by weight based on the total composition, especially in the range from 60% by weight to 92% by weight based on the total composition, preferably in the range from 68% by weight to 90% by weight, more preferably in the range from 70% by weight to 88% by weight and particularly preferably in the range from 70% by weight to 85% by weight in each case based on the total composition.

According to a further embodiment, the present invention therefore also relates to the composition as disclosed above, wherein the proportion of the thermoplastic polyurethane in the composition is in the range from 50% to 95% by weight based on the total composition.

The sum of all components in the composition amounts to 100% by weight in each case.

Preferably employed according to the invention are thermoplastic polyurethanes where the thermoplastic polyurethane has an average molecular weight (MW) in the range from 60 000 to 500 000 Dalton. The upper limit for the average molecular weight (MW) of the thermoplastic polyurethanes is generally determined by processability as well as the spectrum of properties desired. It is more preferable when the thermoplastic polyurethane has an average molecular weight (MW) in the range from 100,000 to 300,000 Da, more preferably in the range from 120,000 to 250,000 Da, especially preferably in the range from 80,000 to 200,000 Da.

According to a further embodiment, the present invention therefore also relates to the composition as disclosed above, wherein the thermoplastic polyurethane has an average molecular weight (M_{W}) in the range from 60 000 to 500 000 Da.

The average molecular weight (M_{W}) in the range from 60 000 to 500 000 Da refers to the thermoplastic polyurethane in the composition, i.e. the thermoplastic polyurethane present after the preparation of the composition.

It has been found according to the invention that especially the use of thermoplastic polyurethanes having a molecular weight (MW) in the range from 100 000 to 300 000 Da results in compositions having particularly advantageous combinations of properties.

It is also possible in accordance with the invention for the composition to comprise two or more thermoplastic polyurethanes differing for example in their average molecular weight or in their chemical composition. For example, the composition according to the invention may comprise a first thermoplastic polyurethane TPU-1 and a second thermoplastic polyurethane TPU-2, for example a thermoplastic polyurethane TPU-1 based on an aliphatic diisocyanate and a further TPU-2 based on an aromatic diisocyanate.

An aliphatic isocyanate is used for producing the TPU-1 while an aromatic isocyanate is used for producing TPU-2.

Preferably employed organic isocyanates (a) for producing the TPU-1 are aliphatic or cycloaliphatic isocyanates, more preferably tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI),1,4-cyclohexane diisocyanate, 1-methyl-2,4- and/or -2,6-cyclohexane diisocyanate and/or 4,4′-, 2,4′- and 2,2′-dicyclohexylmethane diisocyanate.

In a further embodiment the present invention therefore relates to a composition as described hereinabove, wherein the thermoplastic polyurethane TPU-1 is based on at least one aliphatic diisocyanate selected from the group consisting of hexamethylene diisocyanate, pentamethylene diisocyanat and di(isocyanatocyclohexyl)methane.

Preferably employed organic isocyanates (a) for producing the TPU-2 R are araliphatic and/or aromatic isocyanates, more preferably 2,2′-, 2,4′- and/or 4,4′-diphenylmethane diisocyanate (MDI), 1,5-naphthylendiisocyanate (N DI), 2,4- and/or 2,6-tolylene diisocyanate (TDI), 3,3′-dimethyl diphenyl diisocyanate, 1,2-diphenylethane diisocyanate and/or phenylene diisocyanate. It is particularly preferable to use 4,4′-MDI.

In a further embodiment the present invention therefore relates to a composition as described hereinabove, wherein the thermoplastic polyurethane TPU-2 is based on diphenylmethane diisocyanate (MDI).

Preferably employed as isocyanate-reactive compounds (b) for TPU-1 and TPU-2 are a polycarbonate diol or a polytetrahydrofuran polyol. Suitable polytetrahydrofuran polyols have a molecular weight for example in the range from 500 to 5000, preferably 500 to 2000, particularly preferably 800 to 1200.

According to the invention preferably at least one polycarbonate diol, preferably an aliphatic polycarbonate diol, is used for producing the TPU-1 and the TPU-2. Suitable polycarbonate diols include for example polycarbonate diols based on alkanediols. Suitable polycarbonate diols are strictly difunctional OH-functional polycarbonate diols, preferably strictly difunctional OH-functional aliphatic polycarbonate diols. Suitable polycarbonate diols are for example based on butanediol, pentanediol or hexanediol, especially 1,4-butanediol, 1,5-pentanediol, 1,6-hexanediol, 3-methylpentane-(1,5)-diol or mixtures thereof, particularly preferably 1,4-butanediol, 1,5-pentanediol, 1,6-hexanediol or mixtures thereof. Preferably employed in the context of the present invention are polycarbonate diols based on butanediol and hexanediol, polycarbonate diols based on pentanediol and hexanediol, polycarbonate diols based on hexanediol and mixtures of two or more of these polycarbonate diols.

It is preferable when the polycarbonate diols used for producing the TPU-1 and the TPU-2 have a number-average molecular weight Mn in the range from 500 to 4000 determined by GPC, preferably in the range from 650 to 3500 determined by GPC, particularly preferably in the range from 800 to 3000 determined by GPC.

Preferably employable chain extenders (c) for producing the TPU-1 and the TPU-2 include aliphatic, araliphatic, aromatic and/or cycloaliphatic compounds having a molecular weight of 0.05 kg/mol to 0.499 kg/mol, preferably difunctional compounds, for example diamines and/or alkanediols having 2 to 10 carbon atoms in the alkylene radical, di-, tri-, tetra-, penta-, hexa-, hepta-, octa-, nona- and/or decaalkylene glycols having 3 to 8 carbon atoms, especially 1,2-ethylene glycol, 1,3-propanediol, 1,4-butanediol, 1,6-hexanediol, preferably corresponding oligo- and/or polypropylene glycols, wherein mixtures of the chain extenders may also be employed. The compounds (c) preferably have only primary hydroxyl groups and very particularly preference is given to employing mixtures of 1,4-butanediol with a further chain extender selected from the compounds recited above, for example mixtures comprising 1,4-butanediol and a second chain extender in a molar ratio in the range from 100:1 to 1:1, preferably in a range from to 5:1, particularly preferably in a range from 90:1 to 10:1.

In a further embodiment the present invention therefore relates to a composition as described hereinabove, wherein a mixture of 1,4-butanediol and a further chain extender is employed as a chain extender to produce the thermoplastic polyurethane.

In order to adjust the hardness of TPU-1 or TPU-2 the employed amounts of the building block components (b) and (c) may be varied over relatively wide molar ratios, wherein hardness typically increases with increasing content of chain extender (c).

According to the invention the TPU-1 preferably has a hardness in the range from 85A to 70D determined according to DIN ISO 7619-1, preferably in the range from 95A to 70D determined according to DIN ISO 7619-1, more preferably in the range from 55D to 65D determined according to DIN ISO 7619-1.

According to the invention the TPU-2 preferably has a hardness in the range from 70A to 70D determined according to DIN ISO 7619-1, more preferably in the range from 80A to 60D determined according to DIN ISO 7619-1, particularly preferably in the range from 80A to 90A determined according to DIN ISO 7619-1.

In a further embodiment the present invention therefore relates to a composition as described hereinabove, wherein the thermoplastic polyurethane TPU-1 has a Shore hardness in the range from 85A bis 65D determined according to DIN ISO 7619-1. In a further embodiment the present invention therefore relates to a composition as described hereinabove, wherein the thermoplastic polyurethane TPU-2 has a Shore hardness in the range from 70A bis 65D determined according to DIN ISO 7619-1.

The TPU-1 preferably has a molecular weight of more than 100 000 Da and the TPU-2 preferably has a molecular weight in the range from 150 000 to 300 000 Da. The upper limit for the number-average molecular weight of the thermoplastic polyurethanes is generally determined by the processability and also the desired spectrum of properties.

In a further embodiment the present invention therefore relates to a composition as described hereinabove, wherein the thermoplastic polyurethane TPU-1 has a molecular weight in the range from 100 000 Da to 400 000 Da. In a further embodiment the present invention therefore relates to a composition as described hereinabove, wherein the thermoplastic polyurethane TPU-2 has a molecular weight in the range from 150 000 Da to 300 000 Da.

The composition according to the invention comprises the at least one thermoplastic polyurethane TPU-1 and the at least one thermoplastic polyurethane TPU-2 in a sum total amount in the range from 50% by weight to 95% by weight based on the total composition, especially in the range from 68% by weight to 92% by weight based on the total composition, preferably in the range from 70% by weight to 88% by weight, more preferably in the range from 70% by weight to 85% by weight in each case based on the total composition.

In the context of the present invention the ratio of the employed thermoplastic polyurethanes may be varied within a wide range. For example the thermoplastic polyurethane TPU-1 and the thermoplastic polyurethane TPU-2 are employed in a ratio in the range from 2:1 to 1:5. The thermoplastic polyurethane TPU-1 and the thermoplastic polyurethane TPU-2 are preferably employed in a ratio in the range from 1:1 to 1:5, more preferably in the range from 1:2 to 1:4, particularly preferably in the range from 1:2.5 to 1:3.

In a further embodiment the present invention accordingly relates to a composition as described hereinabove, wherein the composition comprises a mixture comprising thermoplastic polyurethane TPU-1 based on an aliphatic diisocyanate and a thermoplastic polyurethane TPU-2 based on an aromatic diisocyanate.

In one embodiment the compositions according to the invention are produced by processing the thermoplastic polyurethane and flame retardants (F1) and (F2) in one step. In other preferred embodiments the compositions according to the invention are produced by initially using a reaction extruder, a belt assembly or other suitable apparatus to produce a thermoplastic polyurethane, preferably as a granulate, into which the flame retardants (F1) and (F2) are then introduced in at least one further step, or else a plurality of steps.

The mixing of the thermoplastic polyurethane with the other components is effected in a mixing unit which is preferably an internal kneader or an extruder, preferably a twin-screw extruder. In a preferred embodiment at least one flame retardant introduced into the mixing unit in the at least one further step is liquid, i.e. liquid at a temperature of 21° C. In another preferred embodiment of the use of an extruder the introduced flame retardant is at least partially liquid at a temperature prevailing downstream of the filling point in the flow direction of the material in the extruder.

According to the invention the composition may comprise further flame retardants, also including phosphorus-containing flame retardants for example. For example the composition may comprise a further phosphorus-containing flame retardant (F3), for example phosphoric esters.

However, in an alternative embodiment the composition according to the invention comprises no further flame retardants in addition to the phosphorus-containing flame retardants (F1) and (F2).

In the context of the present invention the hardness of the compositions according to the invention may be varied within a wide range. The hardness of the composition may be for example in the range from 65A to 80D determined according to DIN ISO 7619-1 (Shore hardness test A (3s)), preferably in the range from 80A to 60D determined according to DIN ISO 7619-1, more preferably in the range from 80A to 95A determined according to DIN ISO 7619-1.

Mechanical properties and flame retardancy properties are optimized according to the invention through the combination of the various flame retardants.

According to the invention the composition may also comprise further constituents, for example standard auxiliary and additive substances for thermoplastic polyurethanes. It is preferable when the composition contains no further flame retardants in addition to the at least one phosphorus-containing flame retardant (F1) and the at least one phosphorus-containing flame retardant (F2). It is more preferable when the composition according to the invention comprises precisely one phosphorus-containing flame retardant (F1) selected from the group consisting of ammonium phosphate and ammonium polyphosphates and precisely one phosphorus-containing flame retardant (F2) selected from the group consisting of derivatives of phosphinic acid.

The composition according to the invention may comprise fillers or dyes for example, preferably in an amount in the range from 0.1% to 5% by weight based on the total composition. In a further embodiment the present invention accordingly relates to a composition as described hereinabove, wherein the composition comprises titanium dioxide in an amount in the range from 0.1% to 5% by weight based on the total composition.

The present invention also relates to the use of the composition according to the invention comprising at least one flame-retarded thermoplastic polyurethane as described hereinabove for the production of coatings, damping elements, bellows, films or fibers, molded articles, floors for buildings and transport, nonwoven fabrics, preferably seals, rollers, shoe soles, hoses, cables, cable connectors, cable sheathings, cushions, laminates, profiles, belts, saddles, foams, plug connectors, trailing cables, solar modules, automotive trim. Use for the production of cable sheathings is preferred. Production is preferably effected from granulates by injection molding, calandering, powder sintering or extrusion and/or by additional foaming of the composition according to the invention.

Accordingly the present invention also relates to the use of a composition comprising at least one thermoplastic polyurethane, a first phosphorus-containing flame retardant (F1) selected from the group consisting of piperazine pyrophosphate and polypiperazine pyrophosphate and a further phosphorus-containing flame retardant (F2) selected from the group consisting of derivatives of phosphinic acid, derivatives of phosphonic acid and derivatives of phosphoric acid as described hereinabove for the production of cable sheathings.

Therefore, according to a further aspect, the present invention is also directed to the use of a composition as disclosed above for the production of cable sheathings. Furthermore, the present invention is also directed to a cable sheathing comprising a composition as disclosed above.

The compositions according to the invention allow the production of particularly thin cables, for example cables having an external diameter of less than 2 mm and a wall thickness of less than 0.5 mm. In a further embodiment the present invention accordingly also relates to the use of a composition as described hereinabove for the production of cable sheathings having a wall thickness in the range from 0.1 to 0.5 mm.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”. Further, it is explicitly noted that the following set of embodiments is not the set of claims determining the extent of protection, but represents a suitably structured part of the description directed to general and preferred aspects of the present invention.

An embodiment (1) of the present invention relates to a composition comprising at least the components (i) to (iii):
(i) a thermoplastic polyurethane,
(ii) a first flame retardant (F1) selected from the group consisting of piperazine pyrophosphate and polypiperazine pyrophosphate;
(iii) a phosphorus-containing flame retardant (F2) selected from the group consisting of derivatives of phosphinic acid, derivatives of phosphonic acid, and derivatives of phosphoric acid.

A further preferred embodiment (2) concretizing embodiment (1) relates to said composition, wherein the flame retardant (F1) is piperazine pyrophosphate.

A further preferred embodiment (3) concretizing any one of embodiments (1) or (2) relates to said composition, wherein the flame retardant (F1) has a water content of less than 1%.

A further preferred embodiment (4) concretizing any one of embodiments (1) to (3) relates to said composition, wherein the flame retardant (F1) has a phosphorous content of more than 15%.

A further preferred embodiment (5) concretizing any one of embodiments (1) to (4) relates to said composition, wherein the flame retardant (F1) comprises silica in an amount in the range of from 0.001 to 5% by weight.

A further preferred embodiment (6) concretizing any one of embodiments (1) to (5) relates to said composition, wherein the flame retardant (F1) has a particle size (d98) in the range from 5 to 100 μm.

A further preferred embodiment (7) concretizing any one of embodiments (1) to (6) relates to said composition, wherein the phosphorus-containing flame retardant (F2) is selected from the group consisting of derivatives of phosphinic acid.

A further preferred embodiment (8) concretizing any one of embodiments (1) to (7) relates to said composition, wherein the composition comprises a further phosphorus-containing flame retardant (F3) selected from the group consisting of derivatives of phosphoric acid.

A further preferred embodiment (9) concretizing any one of embodiments (1) to (8) relates to said composition, wherein the proportion of the sum of the flame retardant (F2) and the phosphorus-containing flame retardant (F3) in the composition is in the range from 1% to 30% by weight based on the total composition.

A further preferred embodiment (10) concretizing any one of embodiments (1) to (9) relates to said composition, wherein the proportion of the flame retardant (F1) is in the range from 1% to 40% by weight based on the overall composition.

A further preferred embodiment (11) concretizing any one of embodiments (1) to (10) relates to said composition, wherein the proportion of the flame retardant (F2) in the composition is in the range from 2% to 25% by weight based on the overall composition.

A further preferred embodiment (12) concretizing any one of embodiments (1) to (11) relates to said composition, wherein the proportion of the flame retardant (F3) in the composition is in the range from 1% to 30% by weight based on the overall composition.

A further preferred embodiment (13) concretizing any one of embodiments (1) to (12) relates to said composition, wherein the thermoplastic polyurethane has an average molecular weight (M_{W}) in the range from 60 000 to 500 000 Da.

A further preferred embodiment (14) concretizing any one of embodiments (1) to (13) relates to said composition, wherein the proportion of the thermoplastic polyurethane in the composition is in the range from 50% to 95% by weight based on the total composition.

A further embodiment (15) relates to a process for preparing a composition comprising at least the components (i) to (iii), comprising the step of mixing the components (i) to (iii):
(i) a thermoplastic polyurethane,
(ii) a first flame retardant (F1) selected from the group consisting of piperazine pyrophosphate and polypiperazine pyrophosphate;
(iii) a phosphorus-containing flame retardant (F2) selected from the group consisting of derivatives of phosphinic acid, derivatives of phosphonic acid, and derivatives of phosphoric acid.

A further preferred embodiment (16) concretizing embodiment (15) relates to said process, wherein the flame retardant (F1) is piperazine pyrophosphate.

A further preferred embodiment (17) concretizing any one of embodiments (15) or (16) relates to said process, wherein the flame retardant (F1) has a water content of less than 1%.

A further preferred embodiment (18) concretizing any one of embodiments (15) to (17) relates to said process, wherein the flame retardant (F1) has a phosphorous content of more than 15%.

A further preferred embodiment (19) concretizing any one of embodiments (15) to (18) relates to said process, wherein the flame retardant (F1) comprises silica in an amount in the range of from 0.001 to 5% by weight.

A further preferred embodiment (20) concretizing any one of embodiments (15) to (19) relates to said process, wherein the flame retardant (F1) has a particle size (d98) in the range from 5 to 100 μm.

A further preferred embodiment (21) concretizing any one of embodiments (15) to (20) relates to said process, wherein the phosphorus-containing flame retardant (F2) is selected from the group consisting of derivatives of phosphinic acid.

A further preferred embodiment (22) concretizing any one of embodiments (14) to (21) relates to said process, wherein the composition comprises a further phosphorus-containing flame retardant (F3) selected from the group consisting of derivatives of phosphoric acid.

A further preferred embodiment (23) concretizing any one of embodiments (15) to (22) relates to said process, wherein the proportion of the sum of the flame retardant (F2) and the phosphorus-containing flame retardant (F3) in the composition is in the range from 1% to 30% by weight based on the total composition.

A further preferred embodiment (24) concretizing any one of embodiments (15) to (23) relates to said process, wherein the proportion of the flame retardant (F1) is in the range from 1% to 40% by weight based on the overall composition.

A further preferred embodiment (25) concretizing any one of embodiments (15) to (24) relates to said process, wherein the proportion of the flame retardant (F2) in the composition is in the range from 2% to 25% by weight based on the overall composition.

A further preferred embodiment (26) concretizing any one of embodiments (15) to (25) relates to said process, wherein the proportion of the flame retardant (F3) in the composition is in the range from 1% to 30% by weight based on the overall composition.

A further preferred embodiment (27) concretizing any one of embodiments (15) to (26) relates to said process, wherein the thermoplastic polyurethane has an average molecular weight (M_{W}) in the range from 60 000 to 500 000 Da.

A further preferred embodiment (28) concretizing any one of embodiments (15) to (27) relates to said process, wherein the proportion of the thermoplastic polyurethane in the composition is in the range from 50% to 95% by weight based on the total composition.

A further embodiment (29) of the present invention relates to the use of a composition according to any of embodiments (1) to (14) for the production of cable sheathings.

A further embodiment (30) of the present invention relates to a process for preparing of cable sheathings wherein a composition according to any of embodiments (1) to (14) is subjected to a shaping step.

A further embodiment (31) of the present invention relates to a cable sheathing comprising a composition according to any of embodiments (1) to (14).

A further embodiment (32) of the present invention relates to a cable sheathing comprising a composition comprising at least the components (i) to (iii):
(i) a thermoplastic polyurethane,
(ii) a first flame retardant (F1) selected from the group consisting of piperazine pyrophosphate and polypiperazine pyrophosphate;
(iii) a phosphorus-containing flame retardant (F2) selected from the group consisting of derivatives of phosphinic acid, derivatives of phosphonic acid, and derivatives of phosphoric acid.

The examples which follow are intended to illustrate the invention but are in no way intended to restrict the subject matter of the present invention.

### EXAMPLES

The examples show that the properties are comparable for the inventive mixtures and common flame-retardant TPU based on melamine cyanurate. The inventive mixtures have the advantage of a low corrosivity and a low smoke toxicity and appear more transparent.

### 1. Example 1 (Starting Materials)

Elastollan 1185A10: TPU of Shore hardness 85A from BASF Polyurethanes GmbH, Elastogranstrasse 60, 49448 Lemforde, based on polytetrahydrofuran polyol (PTHF) having a molecular weight of 1000, butane-1,4-diol, MDI.
Melapur MC 15 ED: Melamine cyanurate (1,3,5-triazine-2,4,6(1H,3H,5H)-trione, compound with 1,3,5-triazine-2,4,6-triamine (1:1)), CAS #: 37640-57-6, BASF SE, 67056 Ludwigshafen, GERMANY, particle size D99%<1=50 μm, D50%<=4.5 μm, water content % (w/w)<0.2.
Melapur 200/70: Melaminpolyphosphat (nitrogen content 42-44wt %, phosphorous content 12-14wt %)), CAS #: 218768-84-4, BASF SE, 67056 Ludwigshafen, GERMANY, particle size D99%<1=70 μm, average particle size D50%<=10 pm, water content % (w/w) <0.3.
Fyrolflex RDP: Resorcinol bis(diphenylphosphate), CAS #: 125997-21-9, Supresta Netherlands B.V., Office Park De Hoef, Hoefseweg 1, 3821 AE Amersfoort, the Netherlands, phosphorous content 10.7%, viscosity at 25° C.=700 mPas, acid number<0.1 mg KOH/g, water content % (w/w)<0.1.
Exolit OP 1230: Aluminum diethylphosphinate, CAS #: 225789-38-8, Clariant Produkte (Deutschland) GmbH, Chemiepark Knapsack, 50351 Hürth, average particle size D50%=20-40 μm, water content % (w/w)<0.2.
Melagard PAP: Piperazine pyrophosphate, Diphosphoric acid, compd. with piperazine (1:1). CAS #: 66034-17-1, Italmatch Chemicals Spa, via S. Tommaso 13, Spoleto (PG), Italy, 06049, phosphorous content 21.5-23.5%, water content % (w/w)<0.5, particle size D98%: 25-50 μm.

### 2. Example 2 (Compositions)

The tables below list compositions in which the parts by weight (PW) of the individual starting materials have been stated. In each case, the mixtures were produced in a ZE 40 A twin-screw extruder from Berstorff with screw length of 35D, divided into 10 barrel sections. Granules were obtained using an underwater pelletizing unit of Gala.

TABLE 1

| | 1 (CB) | 2 (CB) | 3(IE) | 4 (IE) | 5 (IE) | 6 (IE) |
|---|---|---|---|---|---|---|
| Elastollan 1185A10 | 70 | 55 | 70 | 75 | 85 | 82 |
| Exolit OP 1230 | 30 | 10 | 20 | 20 | 10 | 10 |
| Melapur MC 15 ED | | 30 | | | | |
| Melapur 200/70 | 15 | | | | | |
| Fyrolflex RDP | | 5 | | | | 3 |
| Melapur PAP | | | 10 | 5 | 5 | 5 |

TABLE 2

| | 7 (CE) | 8 (IE) | 9 (IE) | 10 (IE) | 11 (IE) | 12 (IE) |
|---|---|---|---|---|---|---|
| Elastollan 1185A10 | 67.5 | 75 | 75 | 85 | 85 | 70 |
| Fyrolflex RDP | 7.5 | | 5 | | 5 | 5 |
| Exolit OP 1230 | | 5 | | 5 | | 3 |
| Melapur MC 15 ED | 25 | | | | | |
| Melapur PAP | | 20 | 20 | 10 | 10 | 10 |

### 3. Example 3 (Mechanical Performance)

The materials were extruded with an Arenz single-screw extruder having a three-zone screw with a mixing section (screw ratio 1:3) to give films having a thickness of 1.6 mm. Density, Shore hardness, tensile strength, tear propagation resistance, abrasion and elongation at break of the corresponding test specimens were measured. All compositions have good mechanical properties. The results are compiled in Tables 3 to 5.

TABLE 3

| | | | 1 (CE) | 2 (CE) | 3(IE) | 4 (IE) |
|---|---|---|---|---|---|---|
| Density | [g/cm³] | DIN EN ISO 1183-1, A | 1.26 | 1.25 | 1.20 | 1.17 |
| Shore hardness | [D] | DIN ISO 7619-1 | 93 | 91 | 88 | 87 |
| Tensile strength | [MPa] | DIN EN ISO 527 | 11 | 17 | 13 | 17 |
| Elongation at break | [%] | DIN EN ISO 527 | 490 | 550 | 540 | 580 |
| Tear strength | [kN/m] | DIN ISO 34-1, B (b | 53 | 55 | 47 | 47 |
| Abrasion | [mm³] | DIN ISO 4649 | 170 | 80 | 141 | 125 |
| Extrusion | | | good | very | good | good |
| processing | | | | good | | |

TABLE 4

| | | | 5 (IE) | 6 (IE) | 7 (CE) | 8 (IE) |
|---|---|---|---|---|---|---|
| Density | [g/cm³] | DIN EN ISO 1183-1, A | 1.15 | 1.16 | 1.23 | 1.21 |
| Shore hardness | [D] | DIN ISO 7619-1 | 85 | 87 | 89 | 83 |
| Tensile strength | [MPa] | DIN EN ISO 527 | 27 | 40 | 34 | 12 |
| Elongation at break | [%] | DIN EN ISO 527 | 610 | 640 | 590 | 580 |
| Tear strength | [kN/m] | DIN ISO 34-1, B (b | 48 | 54 | 60 | 44 |
| Abrasion | [mm³] | DIN ISO 4649 | 83 | 74 | 40 | 222 |
| Extrusion | | | good | very | very | good |
| processing | | | | good | good | |

TABLE 5

| | | | 9 (IE) | 10 (IE) | 11 (IE) | 12 (IE) |
|---|---|---|---|---|---|---|
| Density | [g/cm³] | DIN EN ISO 1183-1, A | 1.21 | 1.17 | 1.17 | 1.17 |
| Shore hardness | [D] | DIN ISO 7619-1 | 81 | 83 | 83 | 87 |
| Tensile strength | [MPa] | DIN EN ISO 527 | 17 | 27 | 37 | 38 |
| Elongation at break | [%] | DIN EN ISO 527 | 600 | 610 | 600 | 680 |
| Tear strength | [kN/m] | DIN ISO 34-1, B (b | 43 | 46 | 51 | 52 |
| Abrasion | [mm³] | DIN ISO 4649 | 130 | 78 | 55 | 78 |
| Extrusion | | | good | good | good | very |
| processing | | | | | | good |

### 4. Example 4 (Flame Retardancy)

In order to evaluate flame retardancy, a test specimen of thickness 5 mm is tested horizontally with radiation of intensity 35 kW/m² in a cone calorimeter in accordance with ISO 5660 part 1 and part 2 (2002-12). The test specimens for the cone measurements with dimensions 100×100×5 mm were injection molded using an Arburg 520S with screw diameter 30 mm. The key parameters for the cone measurements for the different materials are given in Table 6 and Table 7. The inventive examples show similar THE and PH RR in comparison to the comparative examples.

TABLE 6

| | | 1 (CE) | 2 (CE) | 3(IE) | 4 (IE) | 5 (IE) | 6 (IE) |
|---|---|---|---|---|---|---|---|
| Total Heat Release (THR) | [MJ/m²] | 135 | 128 | 144 | 127 | 148 | 146 |
| Peak of heat release | [kW/m²] | 210 | 265 | 245 | 254 | 260 | 301 |
| (PHRR) | | | | | | | |
| Time to ignition | [s] | 65 | 60 | 65 | 60 | 72 | 63 |
| Initial mass | [g] | 67.0 | 63.8 | 64.3 | 63.0 | 61.9 | 59.4 |
| Total mass loss | [g] | 52.8 | 52.2 | 51.9 | 50.3 | 53.7 | 54.7 |

TABLE 7

| | | 7 (CE) | 8 (IE) | 9 (IE) | 10 (IE) | 11 (IE) | 12 (IE) |
|---|---|---|---|---|---|---|---|
| Total Heat Release (THR) | [MJ/m²] | 143 | 132 | 120 | 122 | 145 | 145 |
| Peak of heat release | [kW/m²] | 450 | 171 | 200 | 220 | 441 | 400 |
| (PHRR) | | | | | | | |
| Time to ignition | [s] | 80 | 65 | 63 | 68 | 62 | 61 |
| Initial mass | [g] | 61.9 | 65.3 | 65.1 | 62.8 | 62.7 | 60.1 |
| Total mass loss | [g] | 55.2 | 48.9 | 49.5 | 51.3 | 54.0 | 53.8 |

### 5. Example 5 (Conductivity and Toxicity of the Smoke Gases)

The conductivities determined using DIN EN 60754-2 (2015) were found to be much lower for the inventive examples. Therefore, the inventive mixtures appear to be much less corrosive compared to the comparative mixtures. Also, it was found that the inventive examples form less hydrocyanic acid (HCN) during combustion than the comparative mixtures. The ITC value determined using the NF X 70-100 Part 1+2 (2006) is smaller than found for the comparative examples. The results are given in Table 8 and Table 9.

TABLE 8

| | | | 1 (CE) | 2 (CE) | 3(IE) | 5 (IE) |
|---|---|---|---|---|---|---|
| pH - value | | DIN EN 60754-2 (2015) | 8.8 | 9.0 | 7.0 | 7.6 |
| Conductivity | [μS/mm] | DIN EN 60754-2 (2015) | 24 | 48 | 10.0 | 9.0 |
| ITC | | NF X 70-100 Partie 1 + 2 (2006) | 32 | 62 | 28 | 25 |
| HCN | [mg/g) | NF X 70-100 Partie 1 + 2 (2006) | 12.3 | 25.0 | 11.0 | 8.4 |

TABLE 9

| | | | 6 (IE) | 7 (CE) | 8 (IE) | 12 (IE) |
|---|---|---|---|---|---|---|
| pH - value | | DIN EN 60754-2 (2015) | 7.4 | 9.0 | 8.6 | 7.0 |
| Conductivity | [μS/mm] | DIN EN 60754-2 (2015) | 8.3 | 50 | 14.0 | 11.5 |
| ITC | | NF X 70-100 Partie 1 + 2 (2006) | 25 | 35 | 25 | 24 |
| HCN | [mg/g) | NF X 70-100 Partie 1 + 2 (2006) | 7.9 | 17.4 | 9.4 | 7.7 |

### LITERATURE CITED

EP 0 617 079 A2
WO 2006/121549 A1
WO 03/066723 A2
US 2013/0059955 A1
US 2013/0081853 A1
WO 97/00916 A1
WO 03/066723 A1
WO 2006/121549 A1
U.S. Pat. No. 4,347,334
U.S. Pat. No. 4,467,056
U.S. Pat. No. 4,514,328
U.S. Pat. No. 4,639,331
Kunststoffhandbuch, volume VII, edited by Vieweg and Hochtlen, Carl Hanser Verlag, Munich 1966 (p. 103-113)
EP 0 922 552 A1
DE 101 03 424 A1
WO 2006/072461 A1

1. A composition, comprising at least components (i) to (iii):
(i) a thermoplastic polyurethane,
(ii) a first flame retardant (F1) selected from the group consisting of piperazine pyrophosphate and poly piperazine pyrophosphate; and
(iii) a phosphorus-containing flame retardant (F2) selected from the group consisting of derivatives of phosphinic acid, derivatives of phosphonic acid, and derivatives of phosphoric acid.

2. The composition according to claim 1, wherein the first flame retardant (F1) is piperazine pyrophosphate.

3. The composition according to claim 1, wherein the first flame retardant (F1) has a water content of less than 1% by weight.

4. The composition according to claim 1, wherein the first flame retardant (F1) has a phosphorous content of more than 15%.

5. The composition according to claim 1, wherein the first flame retardant (F1) comprises silica in an amount in the range of from 0.001 to 5% by weight.

6. The composition according to claim 1, wherein the first flame retardant (F1) has a particle size (d98) in the range from 5 to 100 μm.

7. The composition according to claim 1, wherein the phosphorus-containing flame retardant (F2) is a derivative of phosphinic acid.

8. The composition according to claim 1, wherein the composition comprises a further phosphorus-containing flame retardant (F3), which is a derivative of phosphoric acid.

9. The composition according to claim 8, wherein a the proportion of a sum of the phosphorus-containing flame retardant (F2) and the further phosphorus-containing flame retardant (F3) in the composition is in the range from 1% to 30% by weight, based on the total composition.

10. The composition according to claim 1, wherein a proportion of the first flame retardant (F1) is in the range from 1% to 40% by weight, based on the overall composition.

11. The composition according to claim 1, wherein the thermoplastic polyurethane has an average molecular weight (M_{W}) in the range from 50,000 to 500,000 Da.

12. The composition according to claim 1, wherein a proportion of the thermoplastic polyurethane in the composition is in a range from 50% to 94% by weight, based on the total composition.

13. A method for the production of a cable sheathing, the method comprising:
forming a cable sheathing with the composition according to claim 1.
